(19) United States
(12) Patent Application Publication
(10) Pub. No.: US 2003/0130865 A1
(43) Pub. Date: Jul. 10, 2003

(54) Method to achieve off-balance sheet treatment via bifurcated sale and leases

(76) Inventors: James Fitzgibbon, Pleasant Hill, CA (US); Julian Goldberg, Thousand Oaks, CA (US); Kenneth Zuckerbrot, New York, NY (US)

Correspondence Address: GREENBERG-TRAURIG, 1750 TYSONS BOULEVARD, 12TH FLOOR, MCLEAN, VA, 22102, US

(21) Appl. No.: 10/293,954

(22) Filed: Nov. 14, 2002

Related U.S. Application Data
(60) Provisional application No. 60/332,805, filed on Nov. 14, 2001.

(51) Int. Cl. G06F 17/60

(52) U.S. Cl. 705/1

(57) ABSTRACT

A method of achieving off-balance sheet treatment via bifurcated sale and leases. Initially one identifies a real property consisting of land and improvements. Then one determines a value of the improvements and a rental value of the land. Thereafter one estimates a remaining economic useful life of the improvement, a maximum cost associated with the transaction and a maximum cost comprising professional fees, financing fees and closing costs. The entity is capitalized so that substantive non-consolidation of the entity and the company results from the transaction. Title to the improvements is transferred from the company to the entity, and the value of the improvements is transferred from the entity to the company, wherein the company provides no financing of the transferred amount. The land is leased, in a first lease, from the company to the entity for a term equal to the estimated remaining economic useful life of the improvements, wherein under the first lease, the entity has the right to alter or remove the improvements, and whereunder the entity pays to the company a first rent equal to the rental value of the land. Ultimately the land and the improvements are leased, in an operating lease having no extension options and no extension obligations, from the entity to the company, for a term of less than the estimated remaining economic useful life of the improvements, whereunder the company pays a second rent to the entity, and wherein the present value (at a market rate) of the second rent less the first rent is less than the value of the improvements.

This application claims the benefit of U.S. Provisional Patent Application Serial No. 60/332,805, filed Nov. 14, 2001, by James Fitzgibbon et al, the entire disclosure of which is hereby incorporated by reference in its entirety.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The invention relates in general to the field of real estate finance, and in particular to a method to achieve off-balance sheet treatment.

### BACKGROUND OF THE INVENTION

It is desirable to obtain off-balance sheet financing for corporate real estate acquisition, construction, and expansion. Such methods of structured financing, known as a synthetic leases, enable a corporation to use the real estate without listing it as a liability on their balance sheet. This improves the company's return on assets and equity, its reported earnings, its debt to equity ratio and its stock value relative to traditional on-balance sheet debt financing. Such a structure also allows the corporation to realize several tax benefits.

A typical sale and leaseback involves sale of an entire property comprising both land and improvements. At the end of a typical sale and leaseback the corporation must repurchase the asset to maintain ownership. However, repurchase of the aspect in this case is an economic uncertainty.

### SUMMARY OF THE INVENTION

The invention is a novel method of achieving off-balance sheet treatment via bifurcated sale and leases.

The invention provides public corporations with low cost of funds, off-balance sheet financing, with a lower overall lease constant. The corporation maintains complete control over the asset, and realizes substantially all of the equity build up and asset appreciation.

Additional features and advantages of the invention will be set forth in the description which follows, and in part will be apparent from the description, or may be learned by practice of the invention. The objectives and other advantages of the invention will be realized and attained by the structures and methods particularly pointed out in the written description and claims hereof as well as the appended drawing.

To achieve these and other advantages and in accordance with the purpose of the present invention, as embodied and broadly described, there is provided a method of achieving off-balance sheet treatment via bifurcated sale and leases.

It is to be understood that both the foregoing general description and the following detailed description are exemplary and explanatory and are intended to provide further explanation of the invention as claimed. P drawing, which is included to provide a further understanding of the

### BRIEF DESCRIPTION OF THE DRAWINGS

The accompanying invention and is incorporated in and constitutes a part of this specification, illustrates an embodiment of the invention and together with the description serves to explain the principles of the invention.

FIG. 1 is a flow chart depicting the current method.

### DETAILED DESCRIPTION OF A PREFERRED EMBODIMENT

Reference will now be made in detail to the preferred embodiments of the present invention, with one example thereof being illustrated in the accompanying drawing.

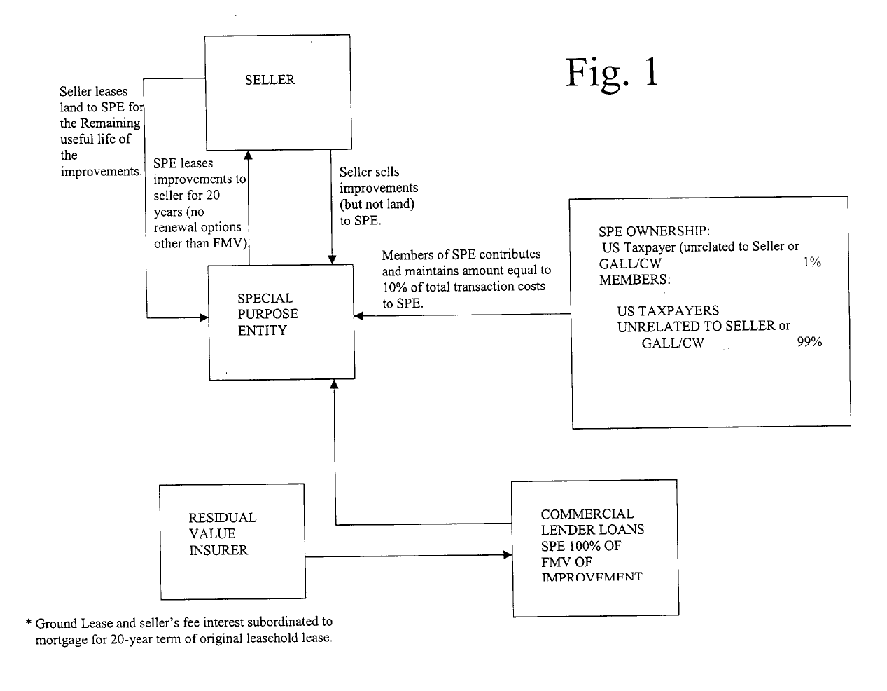

As FIG. 1 illustrates, the invention is directed towards a novel method of achieving off-balance sheet treatment via bifurcated sale and leases. The method is applicable in the context of a real estate transaction, involving a property containing both land and improvements. For example, the property could comprise a beach-front land parcel and a hotel or amusement park improvement located on the parcel. Once the property has been identified, it is necessary to determine the value of the improvements and the rental value of the land. One must then estimate the remaining economic useful life of the improvements, the maximum cost associated with the transaction and the maximum cost comprising professional fees, financing fees and closing costs. Once these initial steps have been carried out, a Special Purpose Gentility (“SPE”) is formed and capitalized.

The SPE is capitalized in a manner that achieves substantive non-consolidation with the seller of the property. The seller then sells the improvements, not the land, to the SPE. For example, in the hotel example listed above the seller would sell the hotel to the SPE but not the underlying parcel of land. The sale is treated as a true sale for tax and accounting purposes. Gain or loss will be realized for income tax purposes on the transaction. The transaction qualifies for sale-leaseback accounting treatment. The SPE pays fair market value for the improvements in cash, obtaining independent financing. The transaction will not impose any limitations on the seller's use of the sales proceeds.

The seller next leases the land to the SPE for a period equal to the estimated remaining useful life of the improvements (the “Ground Lease”), a period estimated to range from 7 to 25 years in excess of the Leaseback described below. The Ground Lease is treated as a lease for tax and financial accounting purposes. The SPE deducts the rent and the seller realizes income. Under the Ground Lease, the SPE has the right to alter, remove, or construct additional improvements, provided that doing so would not cause a material reduction in the fair market value of the land. The improvements on the land will then revert to the seller without additional payment or adjustment upon expiration of the Ground Lease. The seller will not recognize any income for tax purposes from the receipt of income for tax purposes from the receipt of the improvements.

Next the SPE leases the land and the improvements to the seller for a period of 15 to 20 years under a Triple Net Bond Lease (the “Leaseback”). The purchase price for the improvements and the rents payable under the Ground Lease and the Leaseback are all based on an appraisal of fair market values and fair rental values of the improvements and the land. The Leaseback has no extensions or renewal options. At the end of the primary term of the Leaseback the Seller will surrender possession of the improvements unless the seller and the SPE have extended the Leaseback or entered into a new lease of the land and improvements on market terms. If the Seller does not continue in possession, the SPE must either lease the land and improvements at market value to another party, or sell the improvements subject to the Ground Lease. As a result, the Seller can determine prior to the end of the primary term of the Lease back whether to remain in possession of the land and improvements at a fair market rent, or to seek space elsewhere. The Ground Lease will be extended if the seller does not re-lease the improvements.

In order to obtain financing for its acquisition of the improvements, the SPE pledges the improvements and Leaseback to the lender. The Ground Lease is subordinated to the leasehold mortgage. The Seller's fee interest in the land will also be subordinated to the loan for the primary term of the Leaseback. As a result, if a lender exercises his rights to the Leaseback upon a default of the SPE, the lender will be entitled to extend the term of the Ground Lease (if unable to recover principal, interest, and costs on the loan during the original term) and to accrue (but not pay) rent on the Ground Lease until such time as the lender has recovered principal, interest and cost on the loan. The fixed, net level rent on the Leaseback (rent payable under the Leaseback minus the rent payable under the Ground Lease) will be in an amount sufficient to amortize the original purchase loan amount to a level determined by the lender.

At the end of the primary term of the Leaseback, the SPE will have to refinance its acquisition debt. A residual value insurance provider (the “Insurer”) will issue a policy for the benefit of the lender with respect to the value of the improvements and the Ground Lease at the end of the primary term of the Leaseback. If the terms of a new lease or sale of the improvements are not sufficient to allow the refinancing, the lender will foreclose on the improvements and the Ground Lease, and may seek payment from the insurer. The lender or the Insurer will have the right to extend the Ground Lease at market rents in order to recover principal and interest on the loan.

I claim:

1) A method of conducting a transaction involving real property between a company and an entity, comprising the steps of:
identifying a real property consisting of land and improvements;
determining a value of the improvements;
determining a rental value of the land;
estimating a remaining economic useful life of the improvements;
estimating a maximum cost associated with the transaction, the maximum cost comprising professional fees, financing fees and closing costs;
capitalizing the entity so that substantive non-consolidation of the entity and the company results from the transaction;
transferring title to the improvements from the company to the entity;
transferring the value of the improvements from the entity to the company, wherein the company provides no financing of the transferred amount;
leasing the land, in a first lease, from the company to the entity for a term equal to the estimated remaining economic useful life of the improvements, wherein under the first lease, the entity has the right to alter or remove the improvements, and whereunder the entity pays to the company a first rent equal to the rental value of the land;
leasing the land and the improvements, in an operating lease having no extension options and no extension obligations, from the entity to the company, for a term of less than the estimated remaining economic useful life of the improvements, whereunder the company pays a second rent to the entity, and wherein the present value (at a market rate) of the second rent less the first rent is less than the value of the improvements.
